(19) United States
(12) Patent Application Publication
(10) Pub. No.: US 2016/0010469 A1
(43) Pub. Date: Jan. 14, 2016

(54) HYBRID MANUFACTURING FOR ROTORS

(71) Applicant: Hamilton Sundstrand Corporation, Windsor Locks, CT (US)

(72) Inventor: Changsheng Guo, South Windsor, CT (US)

(21) Appl. No.: 14/329,298

(22) Filed: Jul. 11, 2014

(51) Int. Cl. F01D 5/28; B22F 7/06; B22F 5/04; B05D 1/12; B05D 3/12; B28B 1/00; B28B 11/12; C23C 4/02; C23C 4/12; C23C 4/06; C23C 4/10; C23C 4/18; B23K 26/34; B23K 15/00; B23P 15/00; B22F 3/105

(52) U.S. Cl. CPC F01D 5/282; B22F 3/1055; B22F 7/062; B22F 5/04; B05D 1/12; B05D 3/12; B28B 1/001; B28B 11/12; C23C 4/02; C23C 4/127; C23C 4/06; C23C 4/10; C23C 4/18; B23K 26/345; B23K 15/0086; B23P 15/006; F05D 2230/31; B33Y 10/00

(57) ABSTRACT

A method for manufacturing a rotor includes manufacturing a hub using a conventional manufacturing process and manufacturing an airfoil on the hub using a layer-by-layer additive manufacturing process. A rotor includes a hub that has been manufactured with a conventional manufacturing process and an airfoil that has been manufactured on the hub with a layer-by-layer additive manufacturing process.

### BACKGROUND

The present invention relates to manufacturing rotors, and in particular, to a hybrid manufacturing process for manufacturing rotors.

Rotors are rotating components that can be used to move fluid through a system. Rotors, also called turbine wheels or impellers, include a hub portion that forms a support structure for the rotor and airfoils attached to the hub portion that are used to move air through the rotor. Rotors are typically manufactured using conventional manufacturing processes, including machining, forging, and casting. These conventional manufacturing processes manufacture the hub and the airfoils at the same time and out of the same material. Using conventional manufacturing processes to manufacture rotors has limitations. First, airfoil design is limited due to constraints of conventional manufacturing processes. Limiting airfoil design can lessen the effectiveness and efficiency of rotors, as complex airfoil designs cannot be manufactured using conventional manufacturing processes. Second, using conventional manufacturing processes to manufacture rotors can be costly and time consuming. Manufacturing the airfoils on the rotor can be difficult using conventional manufacturing processes, so these processes have to be completed slowly and with high precision. Third, it is often desirable to manufacture rotors out of nickel or titanium alloys due to the fact that these materials have a high strength and are capable of withstanding high temperatures. Nickel and titanium alloys can be hard to machine with conventional machining processes, which makes it difficult to accurately manufacture rotors made out of nickel and titanium alloys using conventional manufacturing processes.

Rotors can also be manufactured using additive manufacturing processes. Additive manufacturing processes build up a part on a layer-by-layer basis. Using an additive manufacturing process to build a hub portion and airfoils for a rotor also has limitations. First, additive manufacturing processes can be very slow processes when a large volume of material is needed to build the part. Rotors require a large volume of material, so manufacturing a rotor with an additive manufacturing process can be very time consuming. Second, when parts with thick and thin sections are manufactured with additive manufacturing processes, part distortion can occur and affect the properties of the part. Rotors have thick and thin sections, thus rotors built with additive manufacturing processes can be distorted and rendered unsuitable for use due to the distortion. Third, additive manufacturing processes can be very expensive when large parts are manufactured. Equipment used during additive manufacturing processes is limited in size, so it can be expensive to manufacture large parts when only one or a few parts can be manufactured at one time.

### SUMMARY

A method for manufacturing a rotor includes manufacturing a hub using a conventional manufacturing process and manufacturing an airfoil on the hub using a layer-by-layer additive manufacturing process.

A rotor includes a hub that has been manufactured with a conventional manufacturing process and an airfoil that has been manufactured on the hub with a layer-by-layer additive manufacturing process.

### BRIEF DESCRIPTION OF THE DRAWINGS

FIG. 1 is a flowchart showing steps for manufacturing a rotor.

FIG. 2 is a side view of a hub that has been manufactured with a conventional manufacturing process.

FIG. 3 is a side view of an airfoil that is being additively manufactured with a spray process onto the hub.

FIG. 4 is a side view of an airfoil that is being additively manufactured with a laser melting or sintering process onto the hub.

### DETAILED DESCRIPTION

In general, the present disclosure is related to using a hybrid manufacturing method to manufacture a rotor. Rotors include turbine wheels and impellers that comprise a hub and a plurality of airfoils attached to the hub. The hybrid manufacturing method includes using a conventional manufacturing process to manufacture a hub for a rotor and using a layer-by-layer additive manufacturing process to manufacture airfoils on the hub for the rotor. Conventional manufacturing methods can include forging, casting, or machining. Layer-by-layer additive manufacturing methods can include direct metal laser sintering, selective laser sintering, electron beam melting, selective laser melting, cold spraying, or thermal spraying. Using the hybrid manufacturing method to manufacture rotors allows the rotors to be manufactured in a more timely and cost-efficient manner. Further, the design of the airfoils on the rotor can be more complex when the airfoils are manufactured using a layer-by-layer additive manufacturing process, improving the efficiency and effectiveness of the rotor. The airfoils can also be built out of more than one material to allow portions of the airfoil to be built out of materials having different properties. This allows each airfoil to have portions that have a high wear resistance and portions that have a high strength, for example.

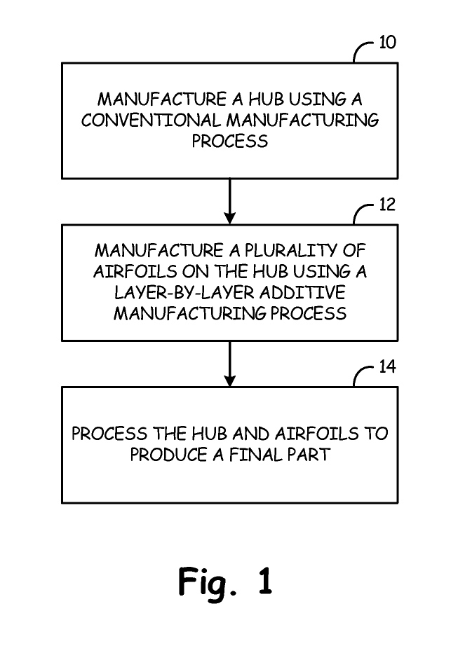

FIG. 1 is a flowchart showing steps for manufacturing a rotor. FIG. 1 includes steps 10-14. Step 10 includes manufacturing a hub using a conventional manufacturing process. Step 12 includes manufacturing a plurality of airfoils on the hub using a layer-by-layer additive manufacturing process. Step 14 includes processing the hub and airfoils to produce a final part.

Step 10 includes manufacturing a hub using a conventional manufacturing process. The hub forms a support structure for a rotor that the airfoils are attached to. The hub typically includes a base portion and a shaft portion extending perpendicularly away from the base portion.

Conventional manufacturing processes can include any manufacturing process that is capable of working a material to form a part. For example, this can include forging, casting, or machining, among others. Forging uses compressive forces to shape a metallic material and can be done at a variety of different temperatures. Casting includes pouring a melted material into a mold, wherein the melted material can harden in the mold to form a part. Machining includes removing material from a starting piece until a final shape is obtained. Machining processes may also be referred to as subtractive manufacturing processes.

The hub has a simple geometry and requires a large volume of material. Using a conventional manufacturing process to manufacture the hub allows the hub to be manufactured quickly and at a low cost. The hub can also be manufactured out of a material that has properties that are desirable for a hub of a rotor, including materials that have a high strength and materials that are capable of withstanding high temperatures.

Step 12 includes manufacturing a plurality of airfoils on the hub using a layer-by-layer additive manufacturing process. The plurality of airfoils are manufactured on and attached to the hub. Each airfoil will have a first side that is attached to the base portion of the hub and a second side that is attached to the shaft portion of the hub. Gaps remain between the plurality of airfoils so that a fluid can flow between the plurality of airfoils when the rotor is being used. The plurality of airfoils can be manufactured on the hub either all at the same time or one airfoil can be manufactured and then the next airfoil can be manufactured. Further, the plurality of airfoils can be manufactured out of the same material at the hub or the plurality of airfoils can be manufactured out of a different material. Each airfoil can also be manufactured out of more than one material when using layer-by-layer additive manufacturing processes.

Layer-by-layer additive manufacturing processes include any manufacturing process that builds up a component layer-by-layer. For example, this can include direct metal laser sintering, selective laser sintering, electron beam melting, selective laser melting, cold spraying, or thermal spraying. Direct metal laser sintering and selective laser sintering both sinter a selected portion of a layer of powder material using a laser. Electron beam melting and selective laser melting both melt a selected portion of a layer of powder material using a laser. Cold spraying includes spraying a powder material onto a surface, wherein the powder particles undergo plastic deformation upon impact with the surface. Thermal spraying includes spraying a melted or heated powder material onto a surface. All of these processes will build a successive layer on the top of the previous layer to produce airfoils that have been built layer-by-layer. The shape of each layer is defined by a data file (such as an STL file), which is used to control the additive manufacturing process.

In prior art processes, the plurality of airfoils and the hub were manufactured together using a conventional manufacturing process. This limited the design of the plurality of airfoils, as conventional manufacturing processes are limited in how complex of a design they can accurately manufacture. Further, manufacturing the plurality of airfoils with a conventional manufacturing process took a lot of time and was expensive due to the complex shape of the plurality of airfoils. The hub and the plurality of airfoils also had to be manufactured out of the same material using conventional manufacturing processes.

Using a layer-by-layer additive manufacturing process to manufacture the plurality of airfoils allows for greater flexibility in the design of the airfoils. Shapes and geometries that were previously impossible with conventional manufacturing processes can be attained using layer-by-layer additive manufacturing processes. Further, using conventional manufacturing processes to manufacture the plurality of airfoils could be timely and expensive, as each airfoil had to be carefully and slowly manufactured. Using a layer-by-layer additive manufacturing process to manufacture the plurality of airfoils is quicker and less expensive, as layer-by-layer additive manufacturing processes can more easily produce the shape and geometry required for the plurality of airfoils. Additionally, the plurality of airfoils only require a small volume of material. Using a layer-by-layer additive manufacturing process is advantageous, as these processes can conserve more material than conventional manufacturing processes.

Further, the hub can be manufactured out of a first material and the plurality of airfoils can be manufactured out of a second material that is different than the first material. This allows both the material for the hub and the material for the airfoils to be selected based on what material properties are desired in each of the hub and the airfoils. For instance, the hub could be made out of a first material that has a high strength and the airfoils can be made out of a second material that is capable of withstanding high temperatures. Materials that can be used to manufacture the hub and the airfoils can include titanium alloys, nickel alloys, aluminum alloys, ceramic materials, or any other suitable material. Different grade titanium alloys and different grade nickel alloys can also be used. For example, the hub can be made out of a first grade titanium alloy and the airfoils can be made out of a second grade titanium alloy. Alternatively, the hub can be made out of a titanium alloy and the airfoils can be made out of a nickel alloy, or vice versa. This allows the hub and the airfoils to be made out of a material that is tailored to withstand the stresses and temperatures present in each of the hub and the airfoils.

Furthermore, a first portion of an airfoil can be manufactured out of a first airfoil material and a second portion of the airfoil can be manufactured out of a second airfoil material that is different than the first airfoil material. This allows each airfoil to be designed with precision based on what portion of the airfoil needs to be able to withstand high stresses and what portion of the airfoils needs to be able to withstand high temperatures. For instance, the first portion of the airfoil can be made out of a first airfoil material that has a high strength and the second portion of the airfoil can be made out of a second airfoil material that is capable of withstanding high temperatures. Materials that can be used to manufacture the airfoils can include titanium alloys, nickel alloys, aluminum alloys, ceramic materials, or any other suitable material. Different grade titanium alloys and different grade nickel alloys can also be used. For example, a first portion of the airfoil can be made out of a first grade titanium alloy and a second portion of the airfoil can be made out of a second grade titanium alloy. Alternatively, a first portion of the airfoil can be made out of a titanium alloy and a second portion of the airfoil can be made out of a nickel alloy, or vice versa. This allows each portion of the airfoil to be made out of a material that is tailored to withstand the stresses and temperatures present in that portion. Further, a thermal barrier layer (for example zirconia) and/or a wear resistant layer (for example ceramic materials) can be added to an outer surface of the airfoils using a layer-by-layer additive manufacturing process. Using a layer-by-layer additive manufacturing process allows for greater flexibility in the design of the rotor, making the rotor stronger, more heat resistant, and ultimately more effective.

Step 14 includes processing the hub and airfoils to produce a final part. After the plurality of airfoils have been manufactured on the hub, the plurality of airfoils and the hub can be processed to attain a final part. This can include using any number of processes to ensure that the plurality of airfoils and the hub have the desired material properties and mechanical shape. In some cases, the airfoils can also be processed as they are being built. Some of the surfaces of an airfoil with a complex design may be impossible to access after the airfoil has been fully built. Processing the airfoil as it is being built allows all of the surfaces of the airfoil to be finished as the airfoil is built.

The following are examples of processes that can be used to produce a final part. Additional processes can also be used. First, the plurality of airfoils and the hub could be heated to fully sinter and solidify the plurality of airfoils and the hub to form a final part. Second, the plurality of airfoils can undergo a finishing process to get a better surface finish on an exterior of each airfoil. These processes can include multi-axis milling, super abrasive machining, grinding, or finishing with mass media processes such as abrasive flow. The plurality of airfoils can also undergo these finishing processes as they are being built using layer-by-layer additive manufacturing processes.

Using steps 10-14 to manufacture a rotor is advantageous. The hub has a simple geometry, making it time and cost effective to use conventional manufacturing processes to manufacture the hub. Each airfoil of the plurality of airfoils has a complex geometry, making it time and cost effective to use layer-by-layer additive manufacturing processes to manufacture the plurality of airfoils. Further, the plurality of airfoils can be designed with more complex shapes than previously possible with conventional manufacturing processes. The hybrid manufacturing method seen in steps 10-14 takes advantage of the benefits of both conventional manufacturing processes and layer-by-layer additive manufacturing processes to manufacture a rotor that is more effective and efficient than previously possible.

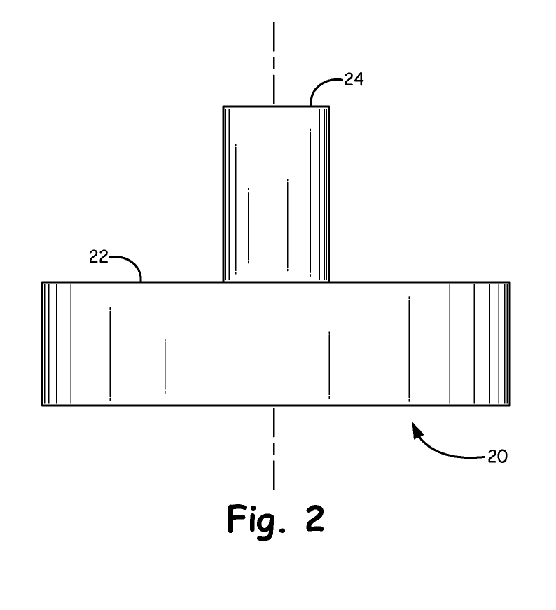

FIG. 2 is a side view of hub 20 that has been manufactured with a conventional manufacturing process. Hub 20 includes base portion 22 and shaft portion 24. Hub 20 is used as a support structure for a rotor. A plurality of airfoils can be attached to hub 20 to form a final rotor.

Hub 20 includes base portion 22 and shaft portion 14. Base portion 22 is a cylindrically shaped piece with a first diameter. Shaft portion 24 is a cylindrically shaped piece with a second diameter. First diameter of base portion 22 is larger than second diameter of shaft portion 24. Shaft portion 24 extends perpendicularly away from base portion 22. In alternate embodiments, hub 20 can have a different shape for alternate rotor designs. Base portion 22 and shaft portion 24 are a single monolithic piece that is formed using a conventional manufacturing process. As seen above in reference to FIG. 1, conventional manufacturing processes can include forging, casting, or machining.

Using a conventional manufacturing process to manufacture hub 20 is advantageous. Hub 20 has a simple design that makes it easy to manufacture. Conventional manufacturing processes can be used to quickly manufacture hub 20 at a low cost.

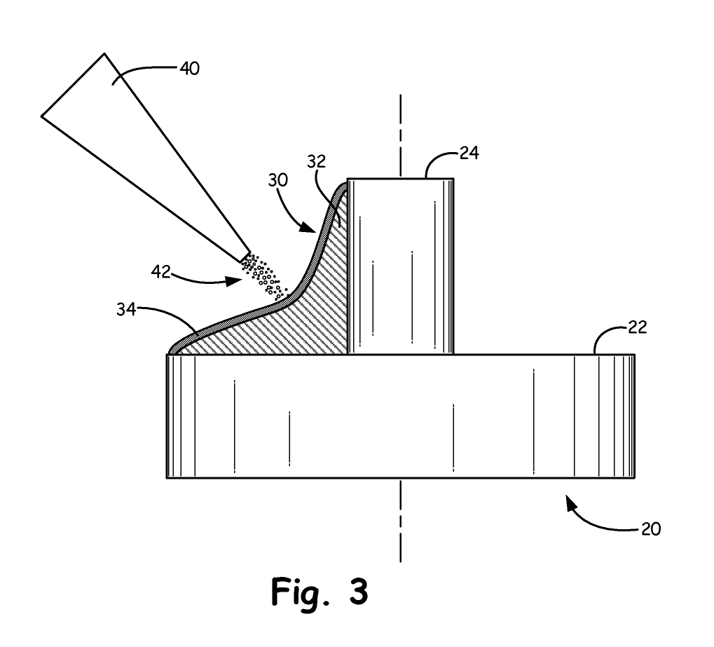

FIG. 3 is a side view of airfoil 30 that is being additively manufactured with a spray process onto hub 20. Hub 20 includes base portion 22 and shaft portion 24. Airfoil 30 includes previously formed portion 32 and layer 34. FIG. 3 also shows sprayer 40 and particles 42.

Hub 20 includes base portion 22 and shaft portion 24 that extends perpendicularly away from base portion 22. Airfoil 30 is being manufactured on hub 20 in FIG. 3 with a spray process. A first layer of airfoil 30 is built onto base portion 22, shaft portion 24, or both base portion 22 and shaft portion 24 at the same time. Airfoil 30 includes previously formed portion 32 and layer 34. Previously formed portion 32 is a portion of airfoil 30 that has already been manufactured using the spray process. Layer 34 is an outer layer of airfoil 30 that has just been applied to airfoil 30 during manufacturing with the spray process.

The spray process can include both cold spray processes and thermal spray processes. The spray process includes sprayer 40. Sprayer 40 is spraying particles 42 onto an outer surface of airfoil 30 to form layer 34. If the spray process is a cold spray process, particles 42 will be powder particles that will undergo plastic deformation and adhere to the outer surface of airfoil 30 when they contact the outer surface of airfoil 30. If the spray process is a thermal spray process, particles 42 will be melted or heated powder particles that will adhere to an outer surface of airfoil 30 due to their melted or heated state. After layer 34 of airfoil 30 has been fully applied, layer 34 will become a part of previously formed portion 32 of airfoil 30. As particles 42 are sprayed onto previously formed portion 32, particles 42 will mechanically bond to previously formed portion 32 to form layer 34. After layer 34 is fully formed, a heat treating process can be used to chemically bond particles 42 of layer 34 to previously formed portion 32. Layer 34 becomes a new outer layer of previously formed portion 32 at this point. Sprayer 40 can then spray a new layer of particles 42 onto airfoil 30. This process can continue layer-by-layer until airfoil 30 is fully built.

The spray process can use different equipment than that shown in FIG. 3 and can include additional steps if needed. For example, multiple sprayers can be used at one time to more quickly build airfoil 30 or a plurality of airfoils 30 on hub 20. Building airfoil 30 with a spray process is advantageous, as airfoil 30 can have more complex designs and geometries than was previously possible with conventional manufacturing processes. Further, airfoil 30 can be manufactured out of a different material than hub 20. This allows hub 20 and airfoil 30 to be built out of a material with properties that are better suited for both hub 20 and airfoil 30. Different portions of airfoil 30 can also be manufactured out of different materials. For example, a first portion of airfoil 30 can be manufactured out of a material that can withstand high temperatures and a second portion of airfoil 30 can be manufactured out of a material that can withstand high stresses. Materials that can be used include nickel alloys, titanium alloys, aluminum alloys, ceramic materials, and any other suitable material. Further, an outer surface of airfoil 30 can be coated with a thermal barrier material (for example zirconia) or a wear resistant material (for example a ceramic material). This allows airfoil 30 to be designed with precision depending on what material properties are best suited for each portion of airfoil 30.

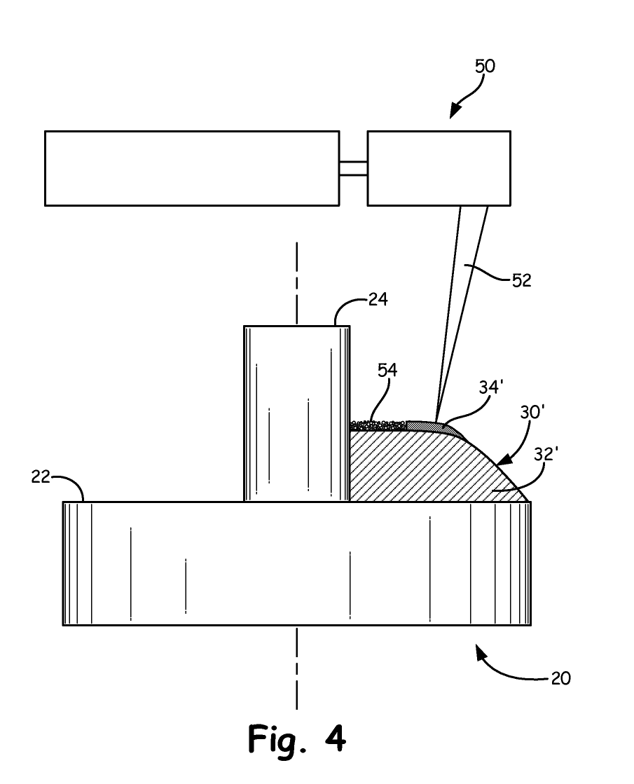

FIG. 4 is a side view of airfoil 30′ that is being additively manufactured with a laser melting or sintering process onto hub 20. Hub 20 includes base portion 22 and shaft portion 24. Airfoil 30′ includes previously formed portion 32′ and layer 34′. FIG. 4 also shows laser 50, beam 52, and powder 54.

Hub 20 includes base portion 22 and shaft portion 24 that extends perpendicularly away from base portion 22. Airfoil 30′ is being manufactured on hub 20 in FIG. 4 with a laser melting or sintering process. A first layer of airfoil 30′ is built onto base portion 22, shaft portion 24, or both base portion 22 and shaft portion 24 at the same time. Airfoil 30′ includes previously formed portion 32′ and layer 34′. Previously formed portion 32′ is a portion of airfoil 30′ that has already been manufactured using the laser melting or sintering process. Layer 34′ is an outer layer of airfoil 30′ that has just been applied to airfoil 30′ during manufacturing with the laser melting or sintering process.

The laser melting or sintering process can include direct metal laser sintering, selective laser sintering, electron beam melting, and selective laser melting. The laser melting or sintering process includes laser 50. Laser 50 has beam 52 that can be directed towards airfoil 30′. To form layer 34′ on an outer surface of airfoil 30′, a layer of powder 54 needs to be spread across the outer surface of airfoil 30′. Laser 50 can then direct beam 52 over powder 54 and selectively melt or sinter powder 54 to form layer 34′ of airfoil 30′. Layer 34′ will then become a part of previously formed portion 32′ of airfoil 30′. Laser 50 will melt or sinter particles 54 and an outer surface of previously formed portion 32′. As particles 54 and the outer surface of previously formed portion 32′ solidify, they will chemically bond together. Layer 34′ becomes a new outer layer of previously formed portion 32′ at this point. Another layer of powder can then be applied across the outer surface of airfoil 30′ and melted or sintered with beam 52 of laser 50. This process can continue layer-by-layer with additional layers of powder 54 being put on top of previously formed portion 32′ of airfoil 30′ until airfoil 30′ is fully built.

The laser melting or sintering process can use different equipment than that shown in FIG. 4 and can include additional steps if needed. For example, the equipment can include a scanning head that is used to move the laser across an entire surface of the rotor. Building airfoil 30′ with a laser melting or sintering process is advantageous, as airfoil 30′ can have more complex designs and geometries than was previously possible with conventional manufacturing processes. Further, airfoil 30′ can be manufactured out of a different material than hub 20. This allows each of hub 20 and airfoil 30′ to be built out of a material with properties that are better suited for hub 20 and airfoil 30′, respectively. Different portions of airfoil 30′ can also be manufactured out of different materials. For example, a first portion of airfoil 30′ can be manufactured out of a material that can withstand high temperatures and a second portion of airfoil 30′ can be manufactured out of a material that can withstand high stresses. Materials that can be used include nickel alloys, titanium alloys, aluminum alloys, ceramic materials, and any other suitable material. Further, an outer surface of airfoil 30′ can be coated with a thermal barrier material (such as zirconia) or a wear resistant material (such as a ceramic material). This allows airfoil 30′ to be designed with precision depending on what material properties are best suited for each portion of airfoil 30′.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A method for manufacturing a rotor, the method comprising:
manufacturing a hub using a conventional manufacturing process; and
manufacturing an airfoil on the hub using a layer-by-layer additive manufacturing process.

2. The method of claim 1, wherein the conventional manufacturing process is a process selected from the group consisting of machining, forging, milling, or combinations thereof.

3. The method of claim 1, wherein the layer-by-layer additive manufacturing process is a process selected from the group consisting of cold spray, thermal spray, plasma spray, selective laser sintering, direct metal laser sintering, electron beam melting, selective laser melting, and combinations thereof.

4. The method of claim 1, wherein manufacturing the hub includes manufacturing the hub out of a first material, and wherein manufacturing the airfoil includes manufacturing the airfoil out of a second material.

5. The method of claim 1, wherein manufacturing the airfoil includes manufacturing a first portion of the airfoil out of a first airfoil material and manufacturing a second portion of the airfoil out of a second airfoil material.

6. The method of claim 1, and further comprising:
manufacturing a plurality of airfoils on the hub using a layer-by-layer additive manufacturing process.

7. The method of claim 6, wherein the plurality of airfoils are manufactured simultaneously.

8. The method of claim 6, wherein the plurality of airfoils are manufactured one at a time.

9. The method of claim 1, and further comprising:
processing the hub and the airfoil to create a final part.

10. The method of claim 9, wherein the processing the hub and the airfoil includes using a process selected from the group consisting of milling, grinding, machining, finishing, and combinations thereof.

11. A rotor comprising:
a hub that has been manufactured with a conventional manufacturing process; and
an airfoil that has been manufactured on the hub with a layer-by-layer additive manufacturing process.

12. The rotor of claim 11, wherein the hub is made of a first material and the airfoil is made out of a second material.

13. The rotor of claim 11, wherein the airfoil has a first portion made of a first airfoil material and a second portion made of a second airfoil material.

14. The rotor of claim 13, wherein the first airfoil material is a material that is capable of withstanding high stress, and wherein the second airfoil material is a material that is a capable of withstanding high temperature.

15. The rotor of claim 11, wherein the rotor further comprises:
a plurality of airfoils that have been manufactured on the hub with a layer-by-layer additive manufacturing process.
